(19) United States
(12) Patent Application Publication
(10) Pub. No.: US 2007/0233375 A1
(43) Pub. Date: Oct. 4, 2007

(54) Providing advertising in aerial imagery

(76) Inventors: Ashutosh Garg, Sunnyvale, CA (US); Mayur Datar, Santa Clara, CA (US)

Correspondence Address: HARRITY SNYDER, LLP, 11350 Random Hills Road, SUITE 600, FAIRFAX, VA, 22030, US

(21) Appl. No.: 11/394,195

(22) Filed: Mar. 31, 2006

(51) Int. Cl. G01C 21/32

(52) U.S. Cl. 701/211

(57) ABSTRACT

A system receives a request from a client and provides an aerial image to the client in response to the request. The aerial image includes an advertisement superimposed on the aerial image.

### FIELD OF THE INVENTION

Implementations consistent with the principles of the invention relate generally to advertising and, more particularly, to providing advertising in aerial imagery.

### BACKGROUND OF THE INVENTION

Various services in the market that combine aerial imagery with maps, such as Google Earth and MSN Virtual Earth, have become quite popular with users. Users tend to look at these maps to gain understanding of an area of interest. The current model to monetize these services is to show advertisements on the side bar. However, users tend to ignore these advertisements since they are not in the area of most interest to users.

### SUMMARY OF THE INVENTION

In accordance with one implementation consistent with principles of the invention, a method may include receiving a map request from a user, retrieving a map in response to the map request, overlaying at least one advertisement on the retrieved map, and providing the retrieved map with the overlaid at least one advertisement to the user.

In another implementation consistent with principles of the invention, a method may include receiving a request from a client, and providing an aerial image to the client in response to the request. The aerial image includes an advertisement superimposed on the aerial image.

In yet another implementation consistent with principles of the invention, a method may include receiving a request that includes a place name or a search term; retrieving an aerial image based on the request; selecting an advertisement based on a location depicted in the aerial image and the place name or search term; superimposing the advertisement on the aerial image; and providing the aerial image with the superimposed advertisement.

### BRIEF DESCRIPTION OF THE DRAWINGS

The accompanying drawings, which are incorporated in and constitute a part of this specification, illustrate one or more implementations of the invention and, together with the description, explain the invention. In the drawings,

FIG. 1 is a diagram illustrating an exemplary concept consistent with principles of the invention;

FIG. 2 is a diagram of an exemplary network in which systems and methods consistent with principles of the invention may be implemented;

FIG. 3 is a diagram of an exemplary client or server entity in an implementation consistent with principles of the invention;

FIG. 4 is a diagram of a portion of an exemplary computer-readable medium that may be used by the server of FIG. 2;

FIG. 5 is a flow chart of an exemplary process for providing advertisements in an implementation consistent with principles of the invention; and

FIGS. 6A-9 provide illustrative examples of the exemplary process of FIG. 5.

### DETAILED DESCRIPTION

The following detailed description of implementations consistent with the principles of the invention refers to the accompanying drawings. The same reference numbers in different drawings may identify the same or similar elements. Also, the following detailed description does not limit the invention.

### Overview

Many on-line mapping services provide aerial maps, which combine aerial imagery with maps. Google Earth and MSN Virtual Earth are two examples of such on-line mapping services. Based on users' queries, relevant/targeted advertisements may be superimposed on the aerial maps provided to the users. In some implementations consistent with principles of the invention, the advertisements may be superimposed on rooftops, sides of buildings (e.g., in three-dimensional aerial maps), parks, tree tops, etc. In this way, advertisers are provided an additional avenue for reaching consumers.

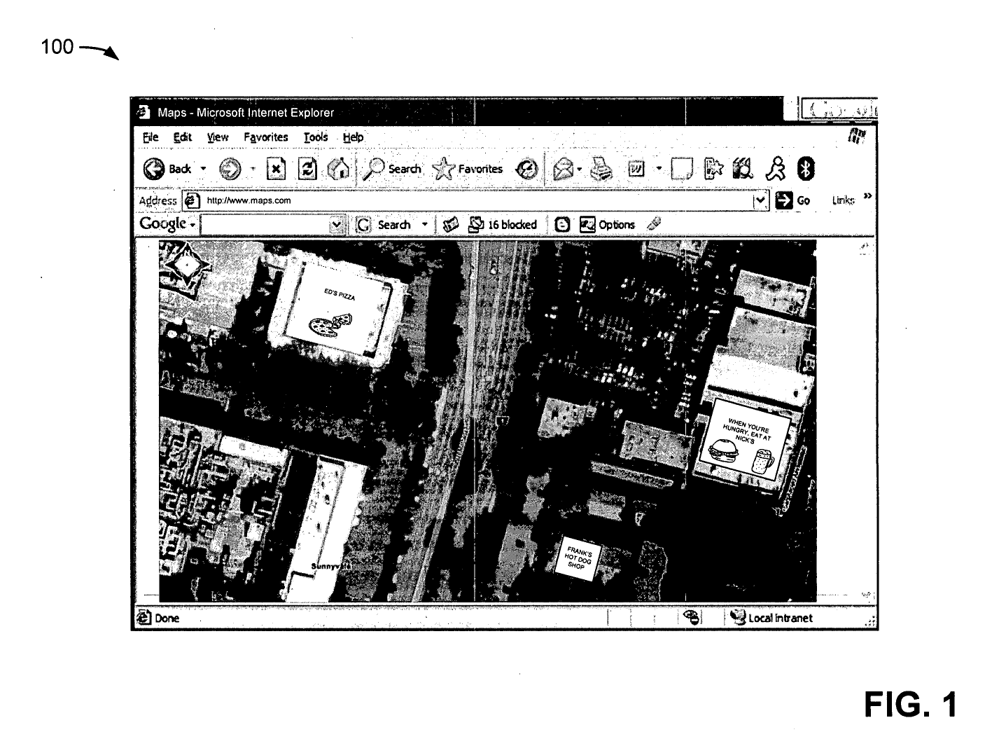

FIG. 1 is a diagram illustrating an exemplary concept consistent with principles of the invention. As illustrated, assume an aerial map 100 is provided to a user. Advertisements (possibly relating to the search performed by the user and/or location depicted in aerial map 100) can be provided to the user in aerial map 100. For example, as illustrated in FIG. 1, advertisements for eating establishments (i.e., Ed's Pizza, Nick's, and Frank's Hot Dog Shop) may be superimposed on aerial map 100 (e.g., on the rooftops of buildings displayed in aerial map 100). In this way, advertising revenue may be obtained in connection with providing aerial maps.

The following description references aerial maps and aerial images. An “aerial map” or “aerial image,” as those terms are used herein, is to be broadly interpreted to include any aerial photograph (e.g., from a satellite or other device) or any aerial rendering of a geographic location.

### Exemplary Network Configuration

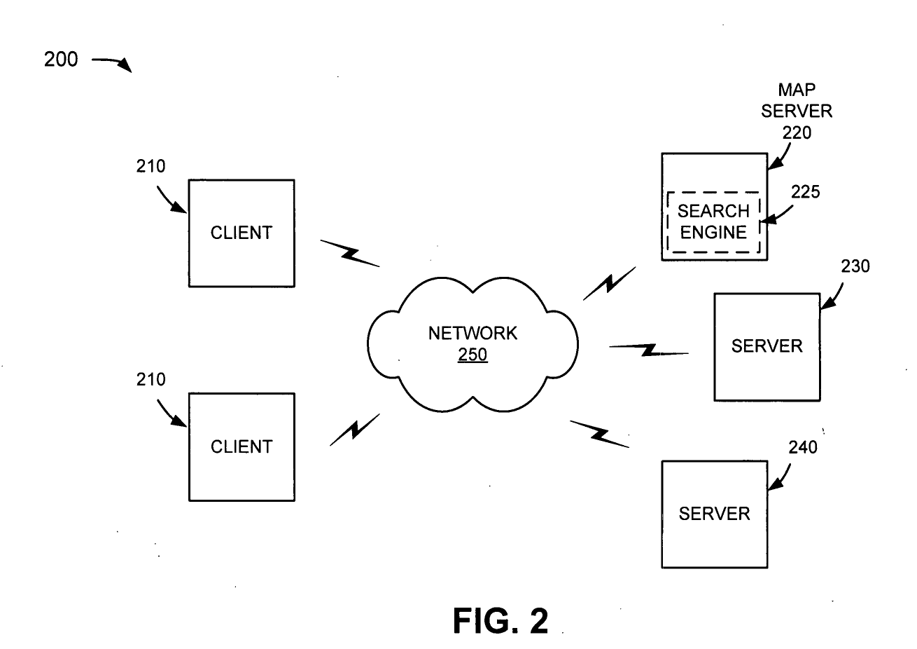

FIG. 2 is a diagram of an exemplary network 200 in which systems and methods consistent with principles of the invention may be implemented. Network 200 may include multiple clients 210 connected to multiple servers 220-240 via a network 250. Two clients 210 and three servers 220-240 have been illustrated as connected to network 250 for simplicity. In practice, there may be more or fewer clients and servers. Also, in some instances, a client may perform a function of a server and a server may perform a function of a client.

Clients 210 may include client entities. An entity may be defined as a device, such as a personal computer, a wireless telephone, a personal digital assistant (PDA), a lap top, or another type of computation or communication device, a thread or process running on one of these devices, and/or an object executable by one of these devices. Servers 220-240 may include server entities that gather, process, search, and/or maintain documents in a manner consistent with the principles of the invention. In an implementation consistent with principles of the invention, server 220 may be implemented as a map server, which provides maps in response to requests from clients 210. In one implementation consistent with principles of the invention, map server 220 may include a search engine 225 usable by clients 210. Server 220 may maintain (or be associated with) a repository of maps and a repository of advertisements.

While servers 220-240 are shown as separate entities, it may be possible for one or more of servers 220-240 to perform one or more of the functions of another one or more of servers 220-240. For example, it may be possible that two or more of servers 220-240 are implemented as a single server. It may also be possible for a single one of servers 220-240 to be implemented as two or more separate (and possibly distributed) devices.

Network 250 may include a local area network (LAN), a wide area network (WAN), a telephone network, such as the Public Switched Telephone Network (PSTN), an intranet, the Internet, another type of network, or a combination of networks. Clients 210 and servers 220-240 may connect to network 250 via wired, wireless, and/or optical connections.

### Exemplary Client/Server Architecture

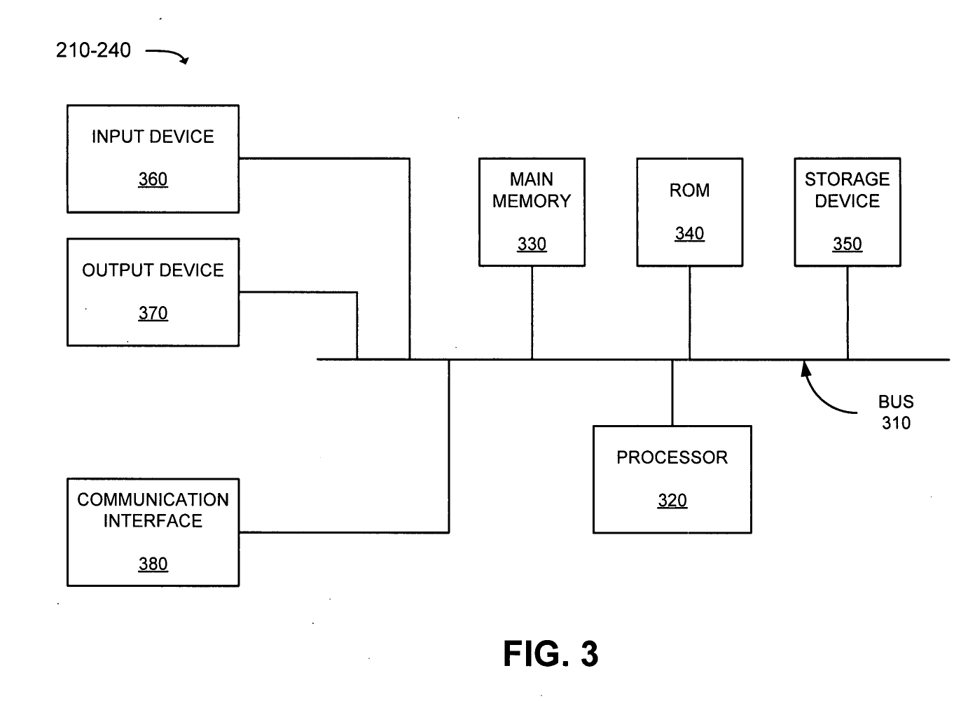

FIG. 3 is an exemplary diagram of a client or server entity (hereinafter called “client/server entity”), which may correspond to one or more of clients 210 and/or servers 220-240. The client/server entity may include a bus 310, a processor 320, a main memory 330, a read only memory (ROM) 340, a storage device 350, an input device 360, an output device 370, and a communication interface 380. Bus 310 may include a path that permits communication among the elements of the client/server entity.

Processor 320 may include a processor, microprocessor, or processing logic that may interpret and execute instructions. Main memory 330 may include a random access memory (RAM) or another type of dynamic storage device that may store information and instructions for execution by processor 320. ROM 340 may include a ROM device or another type of static storage device that may store static information and instructions for use by processor 320. Storage device 350 may include a magnetic and/or optical recording medium and its corresponding drive.

Input device 360 may include a mechanism that permits an operator to input information to the client/server entity, such as a keyboard, a mouse, a pen, voice recognition and/or biometric mechanisms, etc. Output device 370 may include a mechanism that outputs information to the operator, including a display, a printer, a speaker, etc. Communication interface 380 may include any transceiver-like mechanism that enables the client/server entity to communicate with other devices and/or systems. For example, communication interface 380 may include mechanisms for communicating with another device or system via a network, such as network 250.

As will be described in detail below, the client/server entity, consistent with the principles of the invention, may perform certain operations. The client/server entity may perform these operations in response to processor 320 executing software instructions contained in a computer-readable medium, such as memory 330. A computer-readable medium may be defined as a physical or logical memory device and/or carrier wave.

The software instructions may be read into memory 330 from another computer-readable medium, such as data storage device 350, or from another device via communication interface 380. The software instructions contained in memory 330 may cause processor 320 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

### Exemplary Computer-Readable Medium

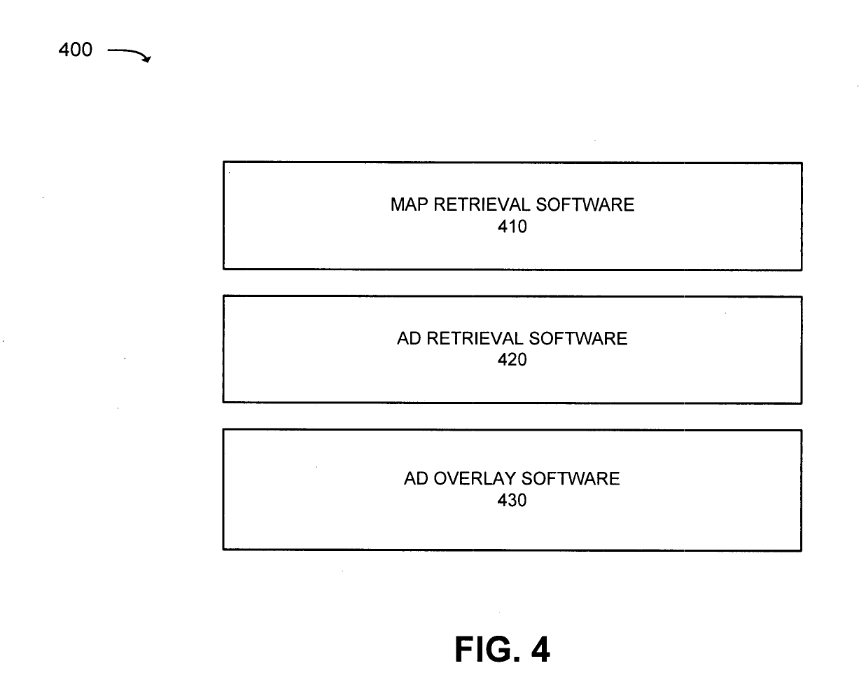

FIG. 4 is a diagram of a portion of an exemplary computer-readable medium 400 that may be used by a server, such as server 220. In one implementation, computer-readable medium 400 may correspond to memory 330 of server 220. In other implementations, computer-readable medium 400 may correspond to a number of memories in one or a number of different servers. The portion of computer-readable medium 400 illustrated in FIG. 4 may include map retrieval software 410, advertisement (AD) retrieval software 420, and advertisement overlay software 430.

Map retrieval software 410 may include software that retrieves a map in response to a map request. For example, in one implementation consistent with principles of the invention, the map request may include an address, a partial address (e.g., a city and state, a zip code, etc.), a place name with or without a partial address (e.g., a business name and a zip code or city/state), a search term or group of search terms with or without a partial address, etc. Map retrieval software 410 may, based on the map request and/or user-profile information, retrieve a map from a repository of maps that most closely matches the request.

Advertisement retrieval software 420 may identify and retrieve one or more advertisements from a repository of advertisements based on a map request, a map retrieved by map retrieval software 410, information associated with a user, and/or other information. Advertisement overlay software 430 may receive a map retrieved by map retrieval software 410 and one or more advertisements retrieved by advertisement retrieval software 420 and overlay the one or more advertisements on the retrieved map. In one implementation consistent with principles of the invention, advertisement overlay software 430 may overlay the one or more advertisements on rooftops of buildings in the retrieved map, on the sides of buildings (if the map is three-dimensional) in the retrieved map, on open spaces in the retrieved map (e.g., in parks, ball fields, playgrounds, vacant lots, tree tops, etc.), or other locations.

### Providing Aerial Imagery with Overlaid Maps

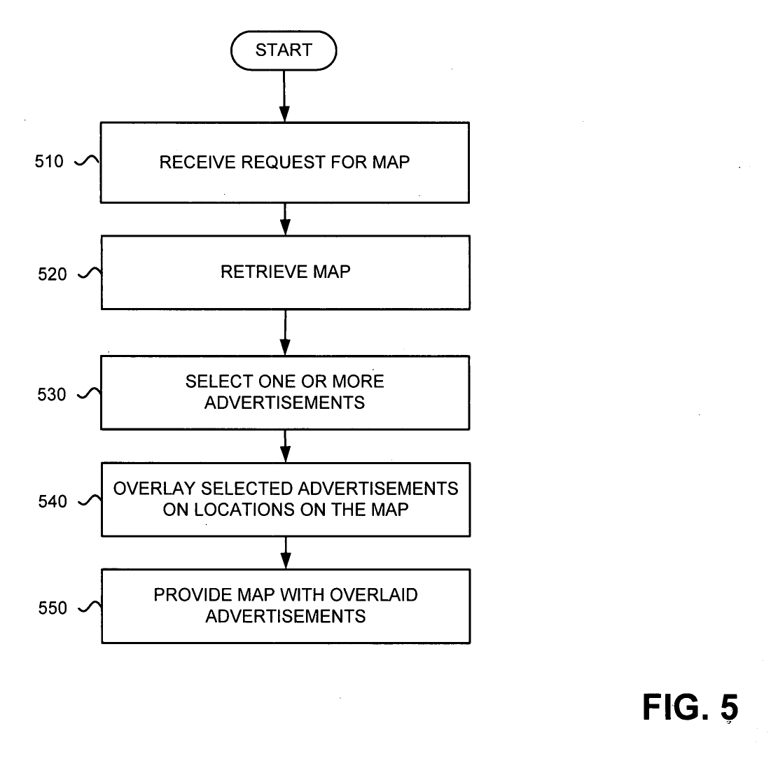

FIG. 5 is a flow chart of an exemplary process for providing advertisements in an implementation consistent with principles of the invention. The processing described with respect to FIG. 5 may be performed by a server, such as server 220, or a group of servers. Moreover, one or more of the acts described below may be performed by a client, such as client 210.

Processing may begin by receiving a request for a map (block 510). The request may be received from a client, such as client 210, a server, such as server 230, or another device in network 200. The request may include, for example, an address (e.g., a street number, a street name, a city, and a state), a partial address (e.g., a zip code), a place name with or without a partial address, a search term or group of search terms with or without a partial address, or other information. An example of an address could be “11350 Random Hills Road, Fairfax, Va., 22030.” Examples of partial addresses include “Fairfax, Va.,” “22030,” “Random Hills Road, 22030,” etc. Examples of place names include “Disney World,” “Dulles Airport,” “Pizza Hut,” etc. As indicated above, a place name could be combined with a partial address, such as “Pizza Hut 22030.” An example of a search term combined with a partial address is “pizza 22030,” which indicates that the user is interested in pizza places in the location corresponding to zip code 22030.

A map may be retrieved based on the request (block 520). For example, server 220 may parse the request to identify the address, partial address, place name, search term(s), and/or other information contained in the request and identify, in a well known manner, a map from a repository of maps based on the address, partial address, place name, search term(s), the profile information associated with the user (e.g., information about the user's previous searches and/or explicit information gathered about the user that includes his/her location), and/or other information. Server 220 may then retrieve the identified map.

One or more advertisements may be selected (block 530). There are a number of factors that may be considered in determining which advertisements in a repository of advertisements to select. In one implementation consistent with principles of the invention, advertisements may be selected as a function of the locality depicted in the retrieved map and/or as a function of the place name, search term or group of search terms in the map request, information associated with the user. In some implementations consistent with the principles of the invention, the selection of advertisements may be a function of the scaling of the retrieved map. For example, the types of advertisements that are selected may be different depending on whether a map of the entire United States or a map of a small town is retrieved. Additionally, the set of candidate advertisements may be entered into a ranking process that decides the priority order in which to display advertisements. This ranking process may take into consideration information such as, for example, the maximum amount that advertisers are willing to pay for a click/impression of the advertisement, the past performance of the advertisement, etc.

When the map request includes only an address or partial address, one or more of the selected advertisements may be selected based on the location depicted in the retrieved map. For example, assume that a map request for zip code “22030” is received and a map corresponding to this location is retrieved. Server 220 may select advertisements for businesses that are located in or near zip code 22030.

When the map request includes a place name, a search term, or group of search terms, one or more of the selected advertisements may be selected based on the place name, search term, or group of search terms. For example, assume that a map request, including the search term “pizza” and the zip code “22030,” is received and a map corresponding to this location is retrieved. Server 220 may select advertisements for pizza establishments and/or other types of restaurants that are located in or near zip code 22030.

In some implementations consistent with principles of the invention, advertisements may be selected based on key words associated with the retrieved map. Some on-line mapping services allow users to “tag” areas of interest. These tags allow users to provide key words for locations on maps that they have retrieved. These tags provide additional information about locations on maps that can be used to select relevant advertisements for those particular locations.

In some implementations consistent with the principles of the invention, advertisements may be selected based on information associated with the user from which the map request is received. For example, server 220 may select advertisements based on the user's interests (e.g., based on the user's search history), advertisements selected by the user, maps retrieved by the user, past purchases, or other behavior of or indications from the user.

The selected advertisements may be overlaid (or superimposed) on the retrieved map (block 540). In one implementation consistent with principles of the invention, the selected advertisements may be placed on building rooftops, on sides of buildings (when the retrieved map is a three-dimensional map), on open spaces in the retrieved map (e.g., in parks, ball fields, playgrounds, vacant lots, on tree tops, etc.), and/or at any other location in the retrieved map. In fact, advertisements may be placed on the retrieved map in any location that does not obscure the user's ability to review the map. In one implementation, the overlay may be of a dynamic nature, i.e., the overlay may appear or disappear in response to certain user interaction, such as hovering of the mouse over an icon shown on the map.

Server 220 may identify locations on the retrieved map to place the advertisements and/or the advertisements may be placed at predetermined locations on the retrieved map. For example, server 220 may identify locations on the retrieved map that are of a predetermined size and substantially uniform color. Depending on the color, these locations may represent rooftops of buildings, tree tops, an open field, etc. Server 220 may, if necessary, scale advertisements to fit into the identified locations.

In some implementations consistent with principles of the invention, maps may be associated with predetermined advertising locations. For example, in one implementation, people, businesses, and/or government organizations (referred to collectively as “groups”) may be allowed to auction their rooftop spaces, sides of their buildings, their open spaces (e.g., vacant lots, parks, school grounds, ball fields, etc.), or the like to advertising networks to allow the advertising networks to place targeted advertisements on these locations. These locations may be marked on the maps stored in the map repository. Thus, when sever 220 retrieves a map, server 220 may readily identify locations at which to place advertisements. In these implementations, the advertising network may share advertisement revenues with the groups auctioning off their virtual space in the aerial images. In some implementations consistent with principles of the invention, the locations to place the advertisements on the aerial map may be determined as a function of the user-profile that may include user-preference information about where the user wishes to see advertisements, past clicks on such advertisements that indicate areas the user is more likely to notice and/or clicks advertisements, etc.

The map with overlaid advertisements may be provided to the requesting device (e.g., client 210), for example, for display to a user. In this way, advertising may be presented to the user as the user is viewing the map. This advertising can bring considerable revenue to the mapping service. For example, the mapping service may charge a fee each time that an advertiser's advertisement is displayed to a user or each time a user clicks on the link associated with the map. Other fee arrangements may alternatively be used. As set forth above, a portion of the collected fees may be shared with entities owning the buildings, land, trees, etc. depicted in retrieved maps.

It will be appreciated that in some implementations consistent with principles of the invention, the advertisements superimposed on the aerial maps may be associated with links, thereby allowing users to obtain additional information regarding a particular advertiser by selecting (e.g., clicking) an advertisement in an aerial map.

### EXAMPLES

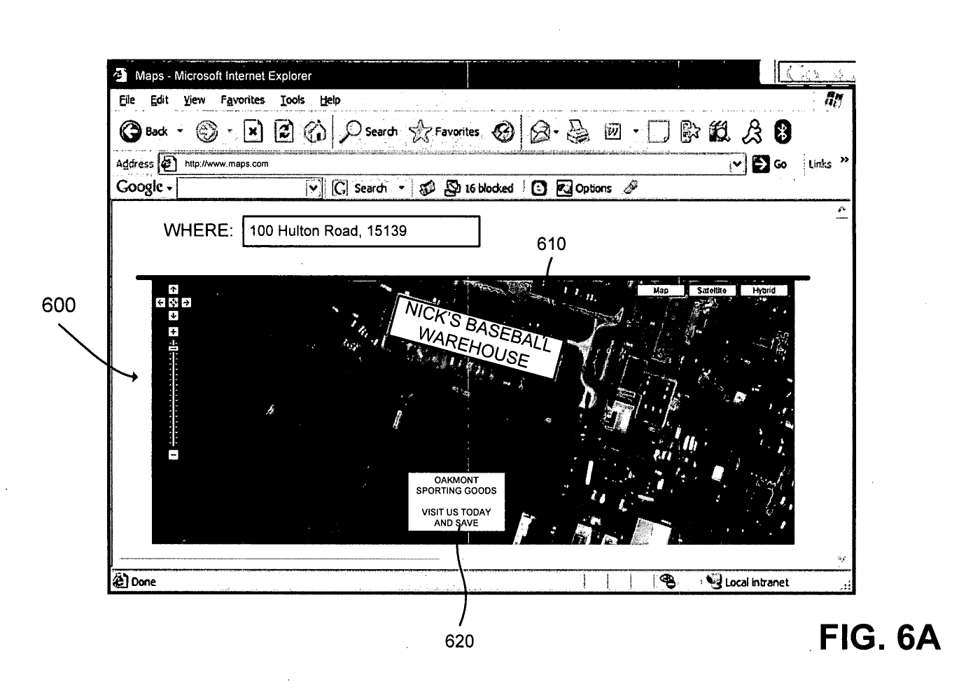

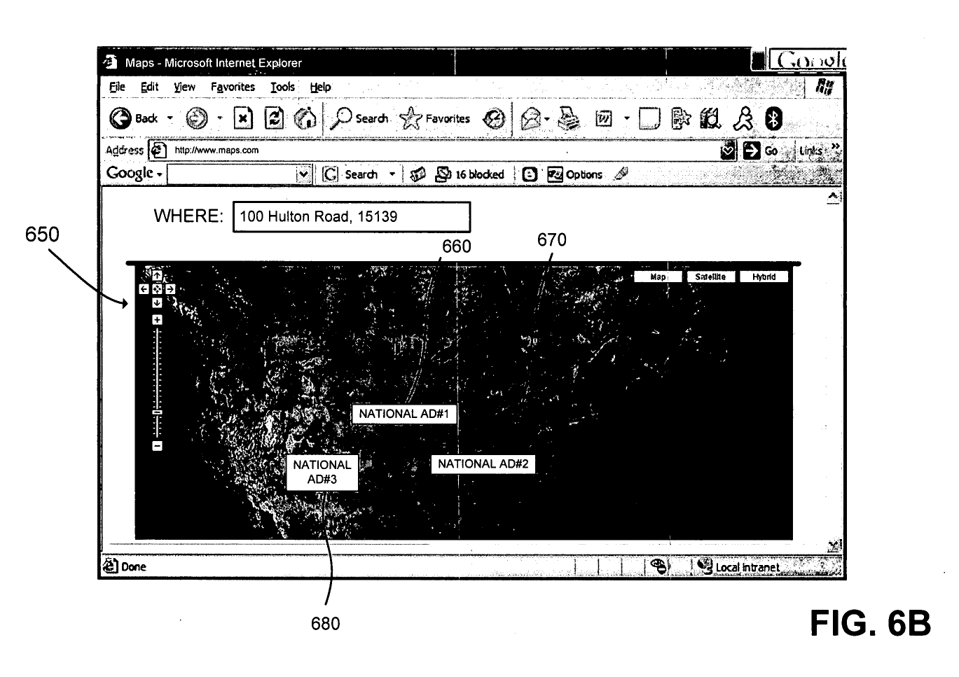

The following examples illustrate the above processing. In the first example, assume that a user requests (e.g., via a client 210) a map of a location corresponding to the address—100 Hulton Road in zip code 15139. In response, a server, such as server 220, may retrieve a map 600, as illustrated in FIG. 6A, corresponding to the requested address. Server 220 may also select one or more advertisements based on the partial address. In the example illustrated in FIG. 6A, server 220 selects advertisements for two businesses (i.e., Nick's Baseball Warehouse and Oakmont Sporting Goods) located in the vicinity of the address. As illustrated in FIG. 6A, server 220 overlays Nick's Baseball Warehouse's advertisement 610 on a top surface of a building and places Oakmont Sporting Goods' advertisement 620 on a ball field in map 600. Server 220 may provide map 600 with overlaid advertisements 610 and 620 to the user.

Assume next that the user zooms out on map 600. In response, assume that server 220 retrieves map 650, illustrated in FIG. 6B, which depicts nearly the entire United States. Server 220 may overlay advertisements 610 and 620 on map 650. Alternatively, server 220 may select a different set (or category) of advertisements based on the location depicted in map 650. Since map 650 depicts nearly the entire United States, server 220 may select advertisements from nationwide businesses. As illustrated in FIG. 6B, server 220 selects advertisements from a first national advertiser 660, a second national advertiser 670, and a third national advertiser 680. Server 220 may overlay these advertisements 660, 670, and 680 in locations that will not obstruct the user's view of map 650. Server 220 may provide map 650 with overlaid advertisements 660, 670, and 680 to the user. Thus, in this example, different categories of advertisements may be selected based on the scale at which the aerial imagery is viewed.

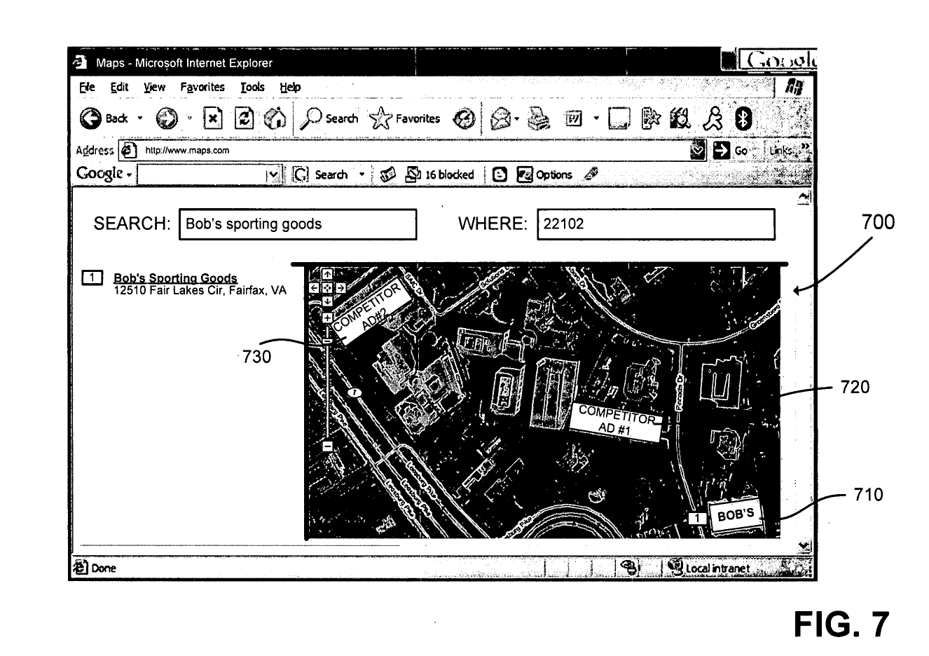

In a second example, assume that a user requests a map that depicts Bob's Sporting Goods in zip code 22102. In response, server 220 may retrieve a map 700, as illustrated in FIG. 7, that depicts the location of Bob's Sporting Goods in zip code 22102 (denoted by a “1” in map 700). Server 220 may also select one or more advertisements based on the location depicted in map 700. Server 220 may overlay an advertisement 710 for Bob's Sporting Goods at its location (or another location) in map 700. Moreover, since the user is searching for a sporting goods store, server 220 may overlay advertisements for other businesses that sell sporting goods. In the example illustrated in FIG. 7, server 220 may overlay an advertisement 720 for a first competitor and an advertisement 730 for second competitor on map 700. Server 220 may provide map 700 with overlaid advertisements 710, 720, and 730 to the user.

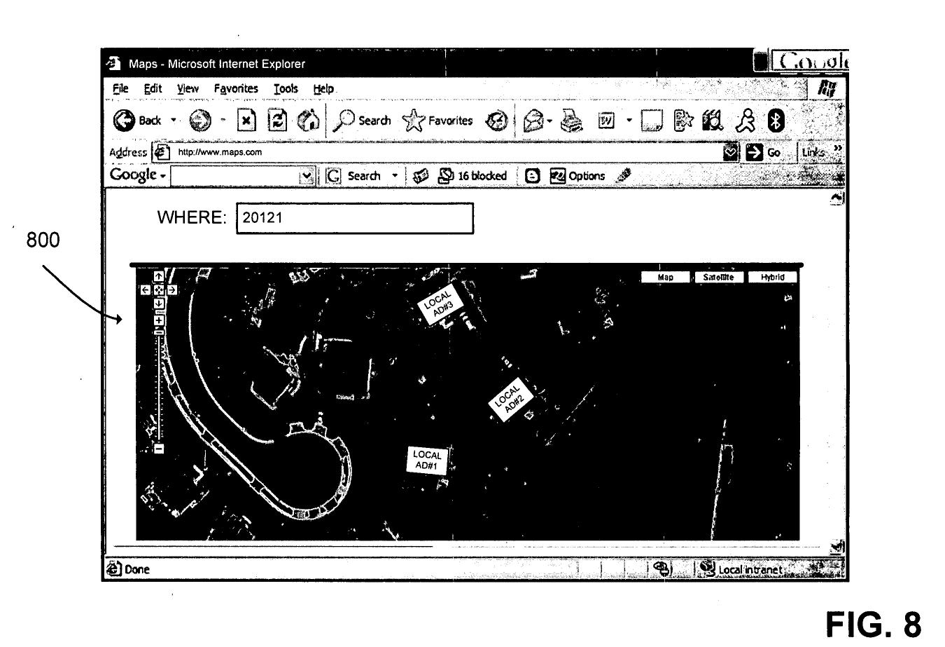

In a third example, assume that residents of a neighborhood in zip code 20121 have auctioned their rooftops to an advertising network. In this way, the residents can share in the revenue that the advertising network collects for placing the advertisements. If a user requests a map for zip code 20121, server 220 may retrieve a map 800, as illustrated in FIG. 8, that depicts all or a portion of zip code 20121. Server 220 may also select one or more advertisements based on the location depicted in map 800 (e.g., for businesses in or around zip code 20121). Server 220 may overlay the selected advertisements on the rooftops of the residents who have auctioned off their rooftops, as illustrated in FIG. 8. Server 220 may provide map 800 with the overlaid advertisements to the user.

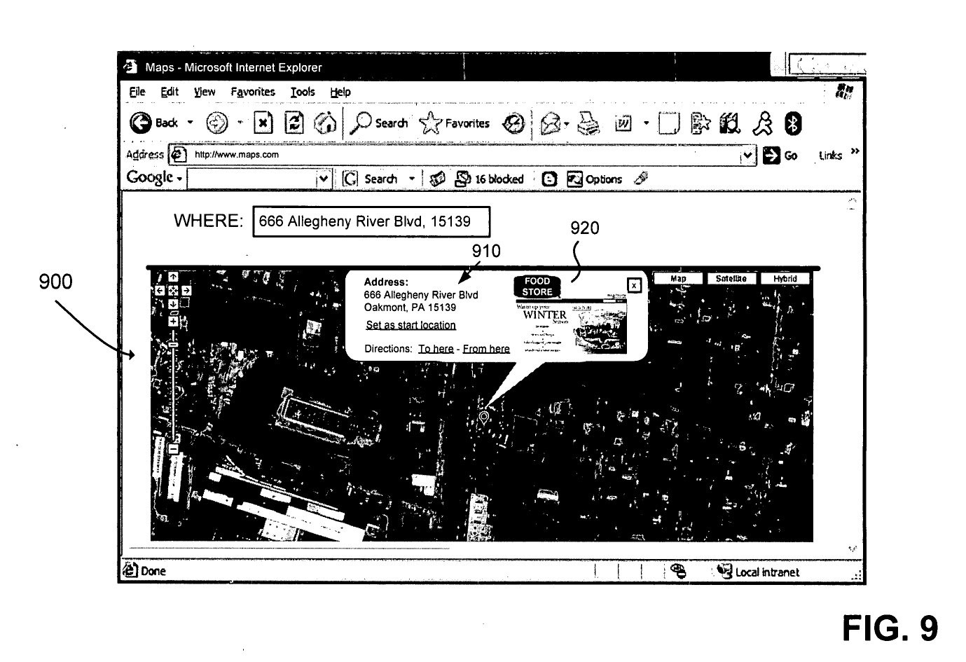

In a fourth example, assume that the user requests a map that depicts the address “666 Allegheny River Boulevard” in zip code 15139. In response, server 220 may retrieve a map 900, as illustrated in FIG. 9, that depicts the requested location, denoted by an icon in FIG. 9. Server 220 may overlay a dialog box 910 on map 900 for the location that allows users to easily obtain driving directions to or from the location. Server 220 may also place one or more advertisements in dialog box 910. In the example illustrated in FIG. 9, the requested address corresponds to a Food Store grocery store. Server 220 provides an advertisement 920 for Food Store in dialog box 910. In other implementations consistent with principles of the invention, server 220 may place advertisements for competitors in dialog box 910 and/or advertisements for other businesses in or around the location depicted in map 900. Server 220 may provide map 900 with advertisement 920 to the user.

### Conclusion

Systems and methods consistent with the principles of the invention may overlay advertisements on aerial imagery provided to users. In this way, advertisers are provided with another avenue to reach consumers.

The foregoing description of exemplary embodiments of the invention provides illustration and description, but is not intended to be exhaustive or to limit the invention to the precise form disclosed. Modifications and variations are possible in light of the above teachings or may be acquired from practice of the invention. For example, while a series of acts has been described with regard to FIG. 5, the order of the acts may be modified in other implementations consistent with the principles of the invention. Further, non-dependent acts may be performed in parallel.

The preceding description refers to a user. A “user” is intended to refer to a client, such as a client 210 (FIG. 2), or an operator of a client

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit or a field programmable gate array, software, or a combination of hardware and software.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving a map request from a user;
retrieving a map in response to the map request;
overlaying at least one advertisement on the retrieved map; and
providing the retrieved map with the overlaid at least one advertisement to the user.

2. The method of claim 1 wherein the overlaying includes:
overlaying the at least one advertisement on a rooftop of a building depicted in the retrieved map.

3. The method of claim 1 wherein the overlaying includes:
overlaying the at least one advertisement on a top of at least one tree in the retrieved map.

4. The method of claim 1 wherein the overlaying includes:
overlaying the at least one advertisement on a side of a building depicted in the retrieved map.

5. The method of claim 1 wherein the overlaying includes:
overlaying the at least one advertisement on an open area in the retrieved map.

6. The method of claim 1 wherein the overlaying includes:
overlaying the at least one advertisement in an area in the retrieved map that does not obscure a view of the retrieved map.

7. The method of claim 1 wherein the overlaying includes:
overlaying the at least one advertisement in a predetermined location in the retrieved map.

8. The method of claim 7 further comprising:
sharing revenue from the at least one advertisement with a group that owns the predetermined location.

9. The method of claim 1 wherein the overlaying includes:
overlaying the at least one advertisement in a way that causes the at least one advertisement to appear or disappear from the retrieved map in response to actions performed by the user.

10. The method of claim 1 further comprising:
selecting the at least one advertisement from a repository of advertisements.

11. The method of claim 10 wherein the selecting includes:
selecting the at least one advertisement based on a location depicted in the retrieved map.

12. The method of claim 10 wherein the selecting includes:
selecting the at least one advertisement based on profile information associated with the user.

13. The method of claim 12 wherein the profile information includes at least one of a past search performed by the user or a past purchase made by the user.

14. The method of claim 10 wherein the map request includes a place name, and wherein the selecting includes:
selecting the at least one advertisement based on the place name and a location depicted in the retrieved map.

15. The method of claim 10 wherein the map request includes at least one search term, and
wherein the selecting includes:
selecting the at least one advertisement based on the at least one search term and a location depicted in the retrieved map.

16. The method of claim 1 wherein the overlaying includes:
overlaying different categories of advertisements based on a scale of the retrieved map.

17. The method of claim 9 wherein the selecting includes:
selecting the at least one advertisement based on a tag associated with the retrieved map.

18. The method of claim 1 wherein the overlaying includes:
overlaying a dialog box on the retrieved map, and
placing the at least one advertisement in the dialog box.

19. A system comprising:
means for receiving a map request;
means for obtaining a map in response to the map request;
means for overlaying at least one advertisement on the retrieved map; and
means for presenting the retrieved map with the overlaid at least one advertisement.

20. A device comprising:
a memory to store instructions; and
a processor to execute the instructions to:
receive a request from a client,
retrieve an aerial image in response to the request,
overlay at least one advertisement on the retrieved aerial image, and
cause the retrieved aerial image with the overlaid at least one advertisement to be provided to the client.

21. A computer-readable medium that stores computer-executable instructions for execution by at least one processor, comprising:
instructions for retrieving an aerial image in response to a request;
instructions for overlaying at least one advertisement on the retrieved aerial image; and
instructions for providing the retrieved aerial image with the overlaid at least one advertisement.

22. A method comprising:
receiving a request from a client; and
providing an aerial image to the client in response to the request, the aerial image including an advertisement superimposed on the aerial image.

23. The method of claim 22 further comprising:
collecting revenue based on the providing.

24. The method of claim 23 further comprising:
sharing the collected revenue with a group that owns a location in the aerial image at which the advertisement is superimposed.

25. The method of claim 22 wherein the request includes an address or a partial address, and
wherein the advertisement relates to the address or partial address.

26. The method of claim 22 wherein the request includes a business name, and
wherein the advertisement relates to a business with which the business name is associated and a location depicted in the aerial image.

27. The method of claim 22 wherein the request includes at least one search term, and
wherein the advertisement relates to the at least one search term and a location depicted in the aerial image.

28. The method of claim 22 wherein the advertisement relates to a tag associated with the aerial image.

29. The method of claim 22 wherein the advertisement relates to profile information associated with a user sending the request.

30. The method of claim 22 wherein the advertisement is superimposed on a dialog box depicted in the aerial image.

31. The method of claim 22 wherein the advertisement relates to at least one of a previous search performed by the client or a past purchase by the client.

32. A system comprising:
a memory to store instructions; and
a processor to execute the instructions to:
receive a request from a user, and
cause an aerial image to be provided to the user in response to the request, the aerial image including an advertisement superimposed on the aerial image.

33. A computer-readable medium that stores computer-executable instructions comprising:
instructions for receiving a map request; and
instructions for providing a map in response to the map request, the map including an advertisement superimposed on the map.

34. A method comprising:
receiving a request that includes a place name or a search term;
retrieving an aerial image based on the request;
selecting an advertisement based on a location depicted in the aerial image and the place name or search term;
superimposing the advertisement on the aerial image; and
providing the aerial image with the superimposed advertisement.
